(19) United States
(12) Patent Application Publication
(10) Pub. No.: US 2026/0006700 A1
(43) Pub. Date: Jan. 1, 2026

(54) LIGHTING DEVICE WITH SELF-TESTING AND GROUP CONTROL FUNCTIONS AND METHOD THEREOF

(71) Applicant: Xiamen PVTECH Co., Ltd., Xiamen (CN)

(72) Inventors: CHENGQUAN XU, Xiamen (CN); FUXING LU, Xiamen (CN)

(73) Assignee: Xiamen PVTECH Co., Ltd., Xiamen (CN)

(21) Appl. No.: 19/238,547

(22) Filed: Jun. 16, 2025

(30) Foreign Application Priority Data
Jun. 28, 2024 (CN) 202410858672.X
Jul. 10, 2024 (CN) 202410927137.5

(51) Int. Cl. H05B 47/115; H05B 45/58

(52) U.S. Cl. CPC H05B 47/115; H05B 45/58

(57) ABSTRACT

The present invention provides a lighting device and the self-testing method thereof. The lighting device includes a communication module, a memory module, a microwave sensing module, a control module, and a light-emitting module. The memory module is connected to the communication module and stores an aging table and a suspect count. The microwave sensing module detects a moving object and generates a detection signal. The control module is connected to the communication module, the microwave sensing module, and the memory module. The light-emitting module is connected to the control module. The control module checks the aging table when the microwave sensing module generates the detection signal, and sets the suspect count to an initial value when determining that a preset number of the trigger records exist within a time window. The control module generates the activation signal to activate the light-emitting module, and broadcasts the activation signal.

### BACKGROUND OF THE INVENTION

### 1. Field of the Invention

The present invention relates to a lighting device, in particular to a lighting device with self-testing and group control functions. The present invention further relates to the self-testing method of the lighting device.

2. DESCRIPTION OF THE PRIOR ART

A lighting device with group sensing and object detection functions (e.g., microwave sensing function) can activate upon detecting a moving object (e.g., a human, a vehicle, etc.) in a target area (e.g., a parking lot, a factory, a production line, a sports fields, etc.) and generate a detection signal. The lighting device may then generate an activation signal based on the detection signal and transmit the detection signal to other lighting devices within the same group to activate them. In this manner, these lighting devices can collectively illuminate the target area.

However, the microwave sensing module in this lighting device is prone to self-excitation due to ripple interference or environmental factors, leading to erroneous detection signals and malfunctioning of the object detection function. As a result, the lighting device may activate even when no moving object is detected.

China Patent No.: CN201601871U and China Patent Publication No.: CN20180570040A both disclose lighting devices with microwave sensing functions, yet these devices still fail to effectively resolve the aforementioned issue.

### SUMMARY OF THE INVENTION

One embodiment of the present invention provides a lighting device with self-testing and group control functions, which includes a communication module, a memory module, a microwave sensing module, a control module, and a light-emitting module. The memory module is connected to the communication module and stores an aging table and a suspect count. The aging table records a plurality of trigger records, and the trigger records are the time points at which the communication module receives the activation signals transmitted from other lighting devices within a preset time interval. The microwave sensing module detects a moving object and generates a detection signal. The control module is connected to the communication module, the microwave sensing module, and the memory module. The light-emitting module is connected to the control module. The control module checks the aging table when the microwave sensing module generates the detection signal, and sets the suspect count to an initial value when determining that a preset number of the trigger records exist within a time window. The control module generates the activation signal based on the detection signal to activate the light-emitting module, and broadcasts the activation signal via the communication module.

In one embodiment, the central point of the time window is the time point when the detection signal is generated.

In one embodiment, the control module checks the aging table when the microwave sensing module generates the detection signal, increases the suspect count by 1 and reduces the sensitivity of the microwave sensing module when determining that the preset number of the trigger records do not exist within the time window. The control module generates the activation signal based on the detection signal to activate the light-emitting module, and broadcasts the activation signal via the communication module.

In one embodiment, the control module checks the aging table when the microwave sensing module generates the detection signal, increase the suspect count by 1 and set the microwave sensing module to an abnormal state when determining that the preset number of the trigger records do not exist within the time window and the suspect count exceeds a preset upper limit. The control module deactivates the microwave sensing module after the microwave sensing module is in the abnormal state.

In one embodiment, the endpoint of the preset time interval of the aging table is the time point of the most recent trigger record generated.

Another embodiment of the present invention provides a self-testing method for a lighting device with a group control function, which includes the following steps: storing an aging table and a suspect count by a memory module, wherein the aging table records a plurality of trigger records, and the trigger records are time points at which a communication module receives activation signals transmitted from other lighting devices within a preset time interval; detecting a moving object by a microwave sensing module to generate a detection signal; checking the aging table when the microwave sensing module generates the detection signal, and setting the suspect count to an initial value when determining that a preset number of the trigger records exist within a time window by a control module; generating the activation signal based on the detection signal to activate a light-emitting module by the control module; and broadcasting the activation signal via the communication module by the control module.

In one embodiment, the central point of the time window is the time point when the detection signal is generated.

In one embodiment, the method further includes the following steps: increasing the suspect count by 1 and reducing the sensitivity of the microwave sensing module when determining that the preset number of the trigger records do not exist within the time window by the control module; generating the activation signal based on the detection signal to activate the light-emitting module by the control module; and broadcasting the activation signal via the communication module by the control module.

In one embodiment, the method further includes the following steps: increasing the suspect count by 1 and setting the microwave sensing module to an abnormal state when determining that the preset number of the trigger records do not exist within the time window and the suspect count exceeds a preset upper limit by the control module; and deactivating the microwave sensing module by the control module after the microwave sensing module is in the abnormal state.

In one embodiment, the endpoint of the preset time interval of the aging table is the time point of the most recent trigger record generated.

The lighting device with self-testing and group control functions and the method thereof in accordance with the embodiments of the present invention may have the following advantages:

(1) In one embodiment of the present invention, the lighting device includes a communication module, a memory module, a microwave sensing module, a control module, and a light-emitting module. The memory module is connected to the communication module and stores an aging table and a suspect count. The aging table records a plurality of trigger records, and the trigger records are the time points at which the communication module receives the activation signals transmitted from other lighting devices within a preset time interval. The microwave sensing module detects a moving object and generates a detection signal. The control module is connected to the communication module, the microwave sensing module, and the memory module. The light-emitting module is connected to the control module. The control module checks the aging table when the microwave sensing module generates the detection signal, and sets the suspect count to an initial value when determining that a preset number of the trigger records exist within a time window. The control module generates the activation signal based on the detection signal to activate the light-emitting module, and broadcasts the activation signal via the communication module. Via the above-self-testing function, the lighting device can self-detect self-excitation, and actively reduces the sensitivity of or deactivates the microwave sensing module when self-excitation repeatedly occurs in order to prevent the faulty lighting device from affecting the group sensing function of other lighting devices. Thus, the lighting system can automatically ignore the microwave sensing function of the faulty lighting device so as to ensure the normal operation of the lighting system. Thus, the lighting system can meet actual requirements.

(2) In one embodiment of the present invention, when the microwave sensing module of the lighting device generates the detection signal, the control module checks the aging table and adjusts the suspect count based on whether the preset number of trigger records exist within the time window. The central point of the time window is the time point when the detection signal is generated. This time window mechanism enables the lighting device to accurately determine whether other lighting devices also detected the moving object and generated detection signals within a fixed period before and after the time point when the detection signal was generated, serving as a reference for the control module to determine whether the microwave sensing module has self-excitation. Therefore, this time window mechanism can effectively enhance the aforementioned self-testing function, so the self-testing function can be more precise.

(3) In one embodiment of the present invention, the control module of the lighting device can execute the self-testing function based on a specially designed aging table, where the endpoint of the preset time interval of the aging table is the time point of the most recently generated trigger record. Thus, the aging table is based on the time dimension. That is to say, the control module can continuously update the aging table, which improves the accuracy of the aforementioned self-testing function to prevent the lighting device from generating erroneous detection signals. In this way, the aforementioned self-testing mechanism can ensure normal operation of the lighting system.

(4) In one embodiment of the present invention, the self-testing function of the lighting device ensures normal operation of the lighting system, enabling effective application of the lighting device in various intelligent systems such as intelligent home systems, intelligent parking systems or other intelligent systems. Therefore, the lighting device can be more comprehensive in application and aligns with the future development trend.

(5) In one embodiment of the present invention, the lighting device features simple design and can implement the self-testing function through a simple and efficient mechanism. Thus, the lighting device can achieve desired effects without significantly increasing costs, so the practicality of the lighting device can be enhanced. Therefore, the lighting device can meet requirements of different applications.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a block diagram of a circuit structure of a lighting device with self-testing and group control functions in accordance with a first embodiment of the present invention.

FIG. 2 is a block diagram of a circuit structure of a lighting device with self-testing and group control functions in accordance with a second embodiment of the present invention.

FIG. 3 is a block diagram of a circuit structure of a lighting device with self-testing and group control functions in accordance with a third embodiment of the present invention.

FIG. 4 is a first flow chart of a self-testing method for a lighting device with a group control function in accordance with a fourth embodiment of the present invention.

FIG. 5 is a second flow chart of the self-testing method for the lighting device with the group control function in accordance with the fourth embodiment of the present invention.

FIG. 6 is a third flow chart of the self-testing method for the lighting device with the group control function in accordance with the fourth embodiment of the present invention.

FIG. 7 is a block diagram of a lighting control system with microwave sensing anomaly detection function in accordance with a fifth embodiment of the present invention.

FIG. 8 is a block diagram of a lighting device of the lighting control system with microwave sensing anomaly detection function in accordance with the fifth embodiment of the present invention.

FIG. 9 is a first flow chart of a microwave sensing anomaly detection method for lighting control system in accordance with a sixth embodiment of the present invention.

FIG. 10 is a second flow chart of the microwave sensing anomaly detection method for lighting control system in accordance with the sixth embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

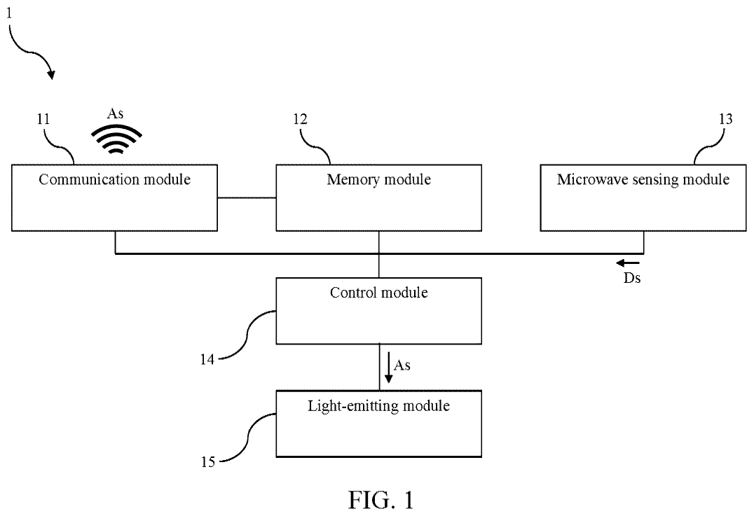

Please refer to FIG. 1, which is a block diagram of a circuit structure of a lighting device with self-testing and group control functions in accordance with a first embodiment of the present invention. As shown in FIG. 1, the lighting device 1 includes a communication module 11, a memory module 12, a microwave sensing module 13, a control module 14, and a light-emitting module 15. A lighting system 1 may include a plurality of lighting devices 1, and these lighting devices 1 have identical structures. Any lighting device I has a microwave sensing function, which can generate an activation signal As to activate the light-emitting module 15 thereof upon detecting a moving object, while simultaneously generating and broadcasting the activation signal As to activate other lighting devices 1. The lighting system is used to provide illumination for a target area, such as a parking lot, factory, production line, sports field, or similar environments.

The communication module 11 can perform wireless communication functions. In one embodiment, the communication module 11 may be an antenna. In another embodiment, the communication module 11 may also be various communication circuits.

The memory module 12 is connected to the communication module 11 and stores the aging table and the suspect count. The aging table records a plurality of trigger records, where these trigger records correspond to the time points at which the communication module 11 receives activation signals As transmitted from other lighting devices within a preset time interval. For example, the preset time interval may be 10 seconds, which can be adjusted based on actual requirements. The number of trigger records may be 4, which can also be adjusted as needed. Additionally, these trigger records may include sequence numbers and identifiers of the respective lighting devices. In one embodiment, the memory module 12 may be flash memory. In another embodiment, the memory module 12 may be any currently available type of memory. An example of the aging table is shown in Table 1 below:

TABLE 1

| Sequence number | Time point | Identifier of lighting device |
|---|---|---|
| 1 | 2024 Feb. 6 10:57:35 | 0x1000 |
| 2 | 2024 Feb. 6 10:57:45 | 0x1004 |
| 3 | 2024 Feb. 6 10:57:48 | 0x1002 |
| 4 | 2024 Feb. 6 10:58:00 | 0x1001 |

The endpoint of the preset time interval in the aging table is the most recent time point at which a trigger record was generated. Therefore, the aging table is based on the time dimension and can be continuously updated.

The microwave sensing module 13 can detect a moving object to generate a detection signal Ds. In one embodiment, the microwave sensing module 13 may be a microwave sensor.

The control module 14 is connected to the communication module 11, the microwave sensing module 13, and the memory module 12. In one embodiment, the control module 14 may be a microcontroller unit (MCU). In another embodiment, the control module 14 may be a central processing unit (CPU), an application-specific integrated circuit (ASIC), a field-programmable gate array (FPGA), or a similar component.

The light-emitting module 15 is connected to the control module 14. In one embodiment, the light-emitting module 15 may be a light-emitting diode LED. In another embodiment, the light-emitting module 15 may be an LED array, a bulb, or another similar light source.

When the microwave sensing module 13 generates the detection signal Ds, the control module 14 checks the aging table. If a preset number of trigger records are found within the time window, the control module 14 sets the suspect count to an initial value (For example, the initial value may be 0 and can be adjusted based on actual requirements; the preset number may be 2 and can also be adjusted as needed). Subsequently, the control module 14 generates the activation signal As based on the detection signal Ds to activate the light-emitting module 15 and broadcasts the activation signal As via the communication module 11. For example, the length of the time window may be 2 seconds (In another embodiment, the time window may be 3 seconds or longer and can be increased or decreased as needed). The central point of the time window is the time point at which the microwave sensing module 13 generates the detection signal Ds. That is, the control module 14 determines whether other lighting devices I have also detected a moving object and generated detection signals Ds within a fixed period before and after the time point of the detection signal Ds. For example, the fixed period may be 0.7 seconds (In another embodiment, the fixed period may be 1 second or longer and can be adjusted as needed). The preset time interval is greater than or equal to twice the fixed period. If other lighting devices 1 have detected the moving object, the control module 14 determines that the detection signal Ds from the microwave sensing module 13 is correct, indicating normal operation. In this case, the control module 14 does not adjust the suspect count and broadcasts the activation signal As to other lighting devices 1 to activate these lighting devices 1.

Conversely, if the microwave sensing module 13 generates the detection signal Ds and the control module 14 determines that the preset number of trigger records are not present within the time window, the control module 14 increases the suspect count by 1 and reduces the sensitivity of the microwave sensing module 13. The control module 14 then generates the activation signal As based on the detection signal Ds to activate the light-emitting module 15 and broadcasts the activation signal As via the communication module 11. That is, the control module 14 checks whether other lighting devices 1 have also detected a moving object and generated detection signals Ds within the fixed period before and after the time point of the detection signal Ds. If not, the control module 14 temporarily cannot confirm the correctness of the detection signal Ds. In this case, the control module 14 increases the suspect count by 1 and reduces the sensitivity of the microwave sensing module 13 to prevent erroneous detection signals Ds. Additionally, the control module 14 broadcasts the activation signal As to other lighting devices 1 to activate these lighting devices 1.

If the microwave sensing module 13 generates the detection signal Ds, the control module 14 determines that the preset number of trigger records are not present within the time window, and the suspect count exceeds a preset upper limit, the control module 14 sets the microwave sensing module 13 to an abnormal state. For example, the preset upper limit may be 3 and can be adjusted as needed. After setting the microwave sensing module 13 to the abnormal state, the control module 14 either deactivates the microwave sensing module 13 or ignores subsequent detection signals Ds from it. That is, the control module 14 checks whether other lighting devices 1 have also detected a moving object and generated detection signals Ds within the fixed period before and after the time point of the detection signal Ds. If not and the suspect count has exceeded the preset upper limit, the control module 14 determines that the detection signal Ds is erroneous and that the microwave sensing module 13 has exhibited repeated self-excitation. At this point, the control module 14 no longer trusts the detection signal Ds from the microwave sensing module 13 and either deactivates it or ignores subsequent detection signals Ds.

As demonstrated above, through the self-testing function of this embodiment, the lighting device 1 can self-detect self-excitation and proactively reduce the sensitivity of or deactivate the microwave sensing module 13 when repeated self-excitation occurs. This ensures that the faulty lighting device 1 does not affect the group sensing function of other lighting devices 1. Thus, the lighting system can automatically disregard the faulty lighting device 1's microwave sensing function, allowing the system to operate normally and meet actual requirements.

Furthermore, in this embodiment, the control module 14 of the lighting device 1 checks the aging table when the microwave sensing module 13 generates the detection signal Ds and adjusts the suspect count based on whether the preset number of trigger records exist within the time window. The central point of the time window is the time point of the detection signal Ds. This time window mechanism enables the lighting device 1 to accurately determine whether other lighting devices 1 have also detected a moving object and generated detection signals Ds within the fixed period before and after the time point of the detection signal Ds. This serves as a reference for the control module 14 to determine whether the microwave sensing module 13 is experiencing self-excitation. Therefore, the time window mechanism effectively enhances the aforementioned self-checking function in order to improve the precision thereof.

Additionally, in this embodiment, the control module 14 of the lighting device 1 can execute the self-testing function based on the specially designed aging table, where the endpoint of the aging table's preset time interval is the most recent time point at which a trigger record was generated. Thus, the aging table is based on the time dimension. That is, the control module 14 can continuously update the aging table, improving the accuracy of the self-testing function and preventing the lighting device 1 from generating erroneous detection signals. This self-checking mechanism ensures the lighting system operates normally.

The embodiment just exemplifies the present invention and is not intended to limit the scope of the present invention; any equivalent modification and variation according to the spirit of the present invention is to be also included within the scope of the following claims and their equivalents.

It is worthy to point out that the microwave sensing module in a currently available lighting device is prone to self-excitation due to ripple interference or environmental factors, leading to erroneous detection signals and malfunctioning of the object detection function. As a result, this lighting device may activate even when no moving object is detected. By contrast, according to one embodiment of the present invention, the lighting device includes a communication module, a memory module, a microwave sensing module, a control module, and a light-emitting module. The memory module is connected to the communication module and stores an aging table and a suspect count. The aging table records a plurality of trigger records, and the trigger records are the time points at which the communication module receives the activation signals transmitted from other lighting devices within a preset time interval. The microwave sensing module detects a moving object and generates a detection signal. The control module is connected to the communication module, the microwave sensing module, and the memory module. The light-emitting module is connected to the control module. The control module checks the aging table when the microwave sensing module generates the detection signal, and sets the suspect count to an initial value when determining that a preset number of the trigger records exist within a time window. The control module generates the activation signal based on the detection signal to activate the light-emitting module, and broadcasts the activation signal via the communication module. Via the above-self-testing function, the lighting device can self-detect self-excitation, and actively reduces the sensitivity of or deactivates the microwave sensing module when self-excitation repeatedly occurs in order to prevent the faulty lighting device from affecting the group sensing function of other lighting devices. Thus, the lighting system can automatically ignore the microwave sensing function of the faulty lighting device so as to ensure the normal operation of the lighting system. Thus, the lighting system can meet actual requirements.

Also, according to one embodiment of the present invention, when the microwave sensing module of the lighting device generates the detection signal, the control module checks the aging table and adjusts the suspect count based on whether the preset number of trigger records exist within the time window. The central point of the time window is the time point when the detection signal is generated. This time window mechanism enables the lighting device to accurately determine whether other lighting devices also detected the moving object and generated detection signals within a fixed period before and after the time point when the detection signal was generated, serving as a reference for the control module to determine whether the microwave sensing module has self-excitation. Therefore, this time window mechanism can effectively enhance the aforementioned self-testing function, so the self-testing function can be more precise.

Further, according to one embodiment of the present invention, the control module of the lighting device can execute the self-testing function based on a specially designed aging table, where the endpoint of the preset time interval of the aging table is the time point of the most recently generated trigger record. Thus, the aging table is based on the time dimension. That is to say, the control module can continuously update the aging table, which improves the accuracy of the aforementioned self-testing function to prevent the lighting device from generating erroneous detection signals. In this way, the aforementioned self-testing mechanism can ensure normal operation of the lighting system.

Moreover, according to one embodiment of the present invention, the self-testing function of the lighting device ensures normal operation of the lighting system, enabling effective application of the lighting device in various intelligent systems such as intelligent home systems, intelligent parking systems or other intelligent systems. Therefore, the lighting device can be more comprehensive in application and aligns with the future development trend.

Furthermore, according to one embodiment of the present invention, the lighting device features simple design and can implement the self-testing function through a simple and efficient mechanism. Thus, the lighting device can achieve desired effects without significantly increasing costs, so the practicality of the lighting device can be enhanced. Therefore, the lighting device can meet requirements of different applications. As set forth above, the lighting device with self-testing and group control functions according to the embodiments of the present invention can indeed achieve great technical effects.

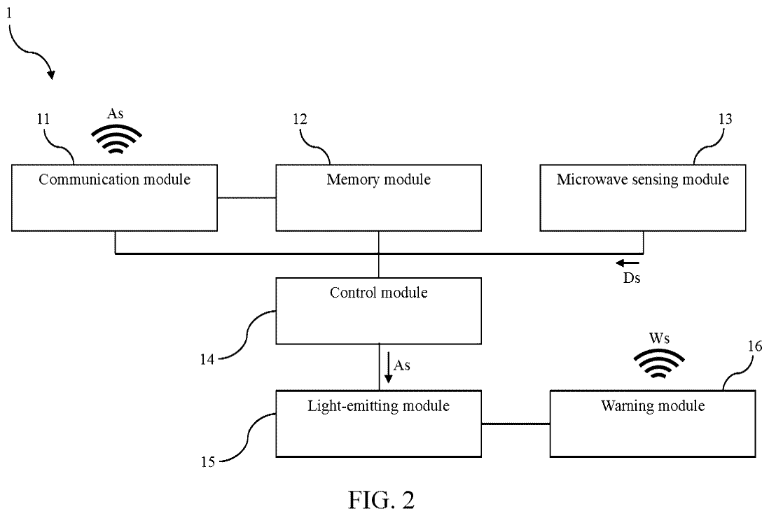

Please refer to FIG. 2, which is a block diagram of a circuit structure of a lighting device with self-testing and group control functions in accordance with a second embodiment of the present invention. As shown FIG. 2, the lighting device 1 includes a communication module 11, a memory module 12, a microwave sensing module 13, a control module 14, and a light-emitting module 15. A lighting system may include a plurality of lighting devices 1, all of which have the same structure. Each lighting device 1 has a microwave sensing function, which can generate an activation signal As to activate its light-emitting module 15 upon detecting a moving object, while simultaneously generating and broadcasting the activation signal As to activate other lighting devices 1. The lighting system is used to provide illumination for a target area (e.g., a parking lot, factory, production line, sports field, etc.).

The memory module 12 is connected to the communication module 11. The control module 14 is connected to the communication module 11, microwave sensing module 13, memory module 12, and light-emitting module 15.

Since the above components are identical to those in the previous embodiment, so these components will not be described in detail here. The difference between this embodiment and the previous embodiment is that the lighting device 1 of this embodiment further includes a warning module 16. The warning module 16 is connected to the control module 14. In one embodiment, the warning module 16 may be a warning light. In another embodiment, the warning module 16 may be a buzzer or other similar component.

Similarly, when the microwave sensing module 13 generates a detection signal Ds, the control module 14 checks the aging table and sets the suspect count to the initial value if a preset number of trigger records are found within the time window. Then, the control module 14 generates the activation signal As based on the detection signal Ds to activate the light-emitting module 15 and broadcasts the activation signal As via the communication module 11.

If the microwave sensing module 13 generates a detection signal Ds but the control module 14 determines that there is no preset number of trigger records within the time window, the control module 14 increases the suspect count by 1 and reduces the sensitivity of the microwave sensing module 13. Then, the control module 14 generates the activation signal As based on the detection signal Ds to activate the light-emitting module 15 and broadcasts the activation signal As via the communication module 11.

As mentioned earlier, if the microwave sensing module 13 generates a detection signal Ds and the control module 14 determines that there is no preset number of trigger records within the time window, the control module 14 increases the suspect count by 1. If the suspect count exceeds a preset upper limit, the microwave sensing module 13 is set to an abnormal state. Subsequently, the control module 14 either shuts down the microwave sensing module 13 or ignores the next detection signal Ds received from the microwave sensing module 13. At the same time, the control module 14 controls the warning module 16 to generate a warning signal Ws to alert the user to repair the lighting device 1.

In this embodiment, when the microwave sensing module 13 generates a detection signal Ds, the control module 14 of the lighting device 1 checks the aging table and adjusts the suspect count based on whether there is a preset number of trigger records within the time window, where the central point of the time window is the time point at which the detection signal Ds is generated. This time window mechanism allows the lighting device 1 to accurately determine whether other lighting devices 1 have also detected a moving object and generated detection signals Ds within a fixed period before and after the time point of the detection signal Ds, serving as a reference for the control module 14 to determine whether the microwave sensing module 13 is experiencing self-excitation. Therefore, this time window mechanism effectively enhances the aforementioned self-testing function, such that the precision of the self-testing function can be enhanced.

Additionally, in this embodiment, the self-testing function of the lighting device 1 ensures the normal operation of the lighting system, allowing the lighting device 1 to be effectively applied to various intelligent systems, such as intelligent home systems, intelligent parking systems, or other similar systems. Thus, the lighting device 1 has broader applications and aligns with future development trends.

Moreover, in this embodiment, the design of the lighting device 1 is simple, and the self-checking function can be implemented through a straightforward and efficient mechanism. As a result, the lighting device 1 achieves the desired function without significantly increasing costs, thereby improving the practicality thereof. Hence, the lighting device 1 can truly meet diverse application requirements.

The embodiment just exemplifies the present invention and is not intended to limit the scope of the present invention; any equivalent modification and variation according to the spirit of the present invention is to be also included within the scope of the following claims and their equivalents.

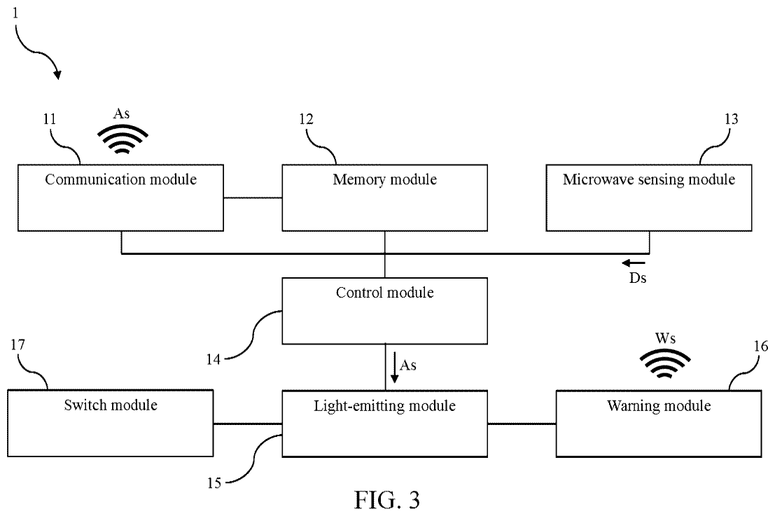

Please refer to FIG. 3, which is a block diagram of a circuit structure of a lighting device with self-testing and group control functions in accordance with a third embodiment of the present invention. As shown in FIG. 3, the lighting device 1 includes a communication module 11, a memory module 12, a microwave sensing module 13, a control module 14, a light-emitting module 15, and a warning module 16. A lighting system may include a plurality of lighting devices 1, all of which have the same structure. Each lighting device 1 has a microwave sensing function, which can generate an activation signal As to activate the light-emitting module 15 thereof upon detecting a moving object, while simultaneously generating and broadcasting the activation signal As to activate other lighting devices 1. The lighting system can provide illumination for a target area (e.g., a parking lot, factory, production line, sports field, etc.).

The memory module 12 is connected to the communication module 11. The control module 14 is connected to the communication module 11, microwave sensing module 13, memory module 12, light-emitting module 15, and warning module 16.

Since the above components are identical to those in the previous embodiment, these components will not be described in detail here. The difference between this embodiment and the previous embodiment is that the lighting device 1 of this embodiment further includes a switch module 17. The switch module 17 is connected to the control module 14. In one embodiment, the switch module 17 may be a DIP switch. In another embodiment, the switch module 17 may be a button, rotary knob, or other similar component.

Similarly, when the microwave sensing module 13 generates a detection signal Ds, the control module 14 checks the aging table and sets the suspect count to the initial value if a preset number of trigger records are found within the time window. Then, the control module 14 generates the activation signal As based on the detection signal Ds to activate the light-emitting module 15 and broadcasts the activation signal As via the communication module 11.

If the microwave sensing module 13 generates a detection signal Ds but the control module 14 determines that there is no preset number of trigger records within the time window, the control module 14 increases the suspect count and reduces the sensitivity of the microwave sensing module 13. Then, the control module 14 generates the activation signal As based on the detection signal Ds to activate the light-emitting module 15 and broadcasts the activation signal As via the communication module 11.

As mentioned earlier, if the microwave sensing module 13 generates a detection signal Ds and the control module 14 determines that there is no preset number of trigger records within the time window, the control module 14 increases the suspect count. If the suspect count exceeds a preset upper limit, the microwave sensing module 13 is set to an abnormal state. Subsequently, the control module 14 either shuts down the microwave sensing module 13 or ignores the next detection signal Ds received from the microwave sensing module 13. At the same time, the control module 14 controls the warning module 16 to generate a warning signal Ws to alert the user to repair the lighting device 1.

The user can disable the aforementioned self-testing function by operating the switch module 17. The user can also re-enable the self-checking function by operating the switch module 17. When the user re-enables the self-testing function via the switch module 17, the control module 14 clears all abnormal information, restoring the lighting device 1 to the initial operating state.

The embodiment just exemplifies the present invention and is not intended to limit the scope of the present invention; any equivalent modification and variation according to the spirit of the present invention is to be also included within the scope of the following claims and their equivalents.

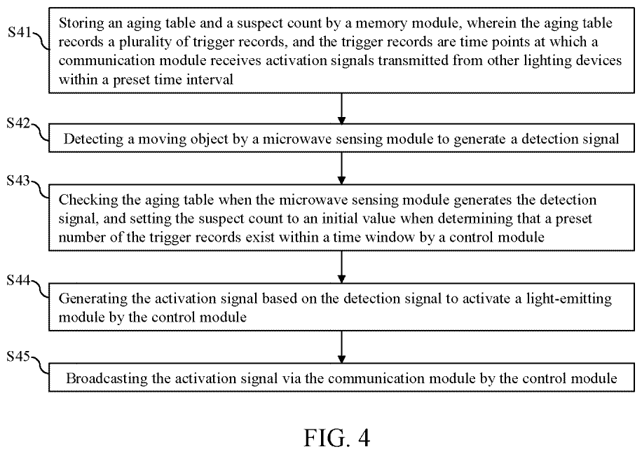

Please refer to FIG. 4, which is a first flow chart of a self-testing method for a lighting device with a group control function in accordance with a fourth embodiment of the present invention. As shown in FIG. 4, the method includes the following steps:
Step S41: storing an aging table and a suspect count by a memory module, wherein the aging table records a plurality of trigger records, and the trigger records are time points at which a communication module receives activation signals transmitted from other lighting devices within a preset time interval.
Step S42: detecting a moving object by a microwave sensing module to generate a detection signal.
Step S43: checking the aging table when the microwave sensing module generates the detection signal, and setting the suspect count to an initial value when determining that a preset number of the trigger records exist within a time window by a control module.
Step S44: generating the activation signal based on the detection signal to activate a light-emitting module by the control module.
Step S45: broadcasting the activation signal via the communication module by the control module.

The embodiment just exemplifies the present invention and is not intended to limit the scope of the present invention; any equivalent modification and variation according to the spirit of the present invention is to be also included within the scope of the following claims and their equivalents.

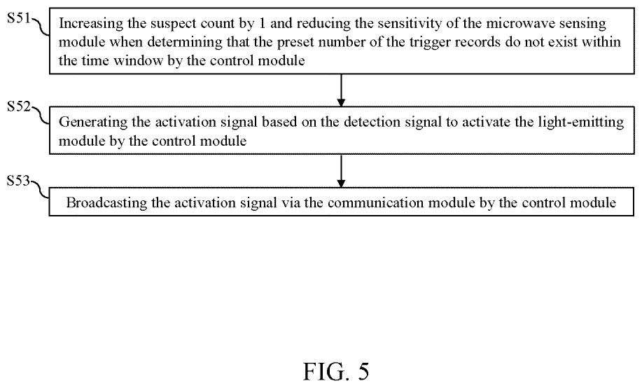

Please refer to FIG. 5, which is a second flow chart of the self-testing method for the lighting device with the group control function in accordance with the fourth embodiment of the present invention. As shown in FIG. 5, the method further includes the following steps:
Step S51: increasing the suspect count by 1 and reducing the sensitivity of the microwave sensing module when determining that the preset number of the trigger records do not exist within the time window by the control module.
Step S52: generating the activation signal based on the detection signal to activate the light-emitting module by the control module.
Step S53: broadcasting the activation signal via the communication module by the control module.

The embodiment just exemplifies the present invention and is not intended to limit the scope of the present invention; any equivalent modification and variation according to the spirit of the present invention is to be also included within the scope of the following claims and their equivalents.

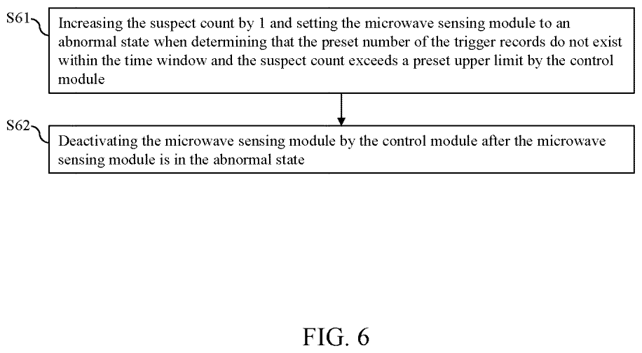

Please refer to FIG. 6, which is a third flow chart of the self-testing method for the lighting device with the group control function in accordance with the fourth embodiment of the present invention. As shown in FIG. 6, the method further includes the following steps:
Step S61: increasing the suspect count by 1 and setting the microwave sensing module to an abnormal state when determining that the preset number of the trigger records do not exist within the time window and the suspect count exceeds a preset upper limit by the control module.
Step S62: deactivating the microwave sensing module by the control module after the microwave sensing module is in the abnormal state.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

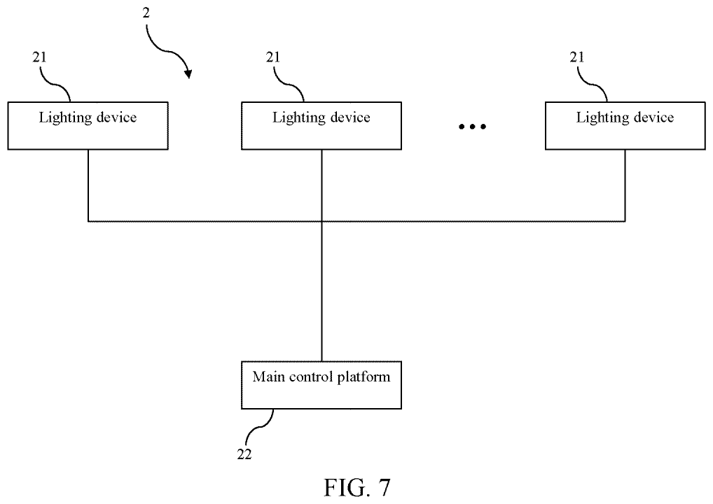

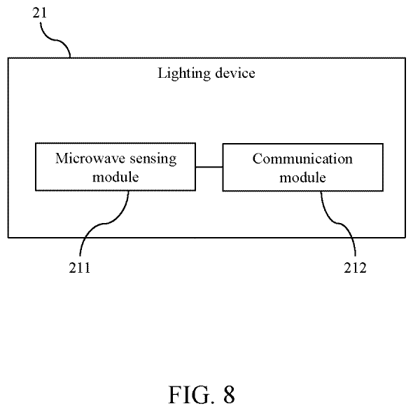

Please refer to FIG. 7 and FIG. 8. FIG. 7 is a block diagram of a lighting control system with microwave sensing anomaly detection function in accordance with a fifth embodiment of the present invention. FIG. 8 is a block diagram of a lighting device of the lighting control system with microwave sensing anomaly detection function in accordance with the fifth embodiment of the present invention. As shown in FIG. 7 and FIG. 8, the lighting control system 2 includes a plurality of lighting devices 21 and a main control platform 22. The lighting devices 21 are connected to the main control platform 22 through wired or wireless means, enabling communication between the main control platform 22 and the lighting devices 21.

The lighting devices 21 are distributed in a target area (such as a parking lot, factory, production line, sports field, etc.). Each lighting device 21 includes a microwave sensing module 211 (e.g., a microwave sensor) and a communication module 212 (e.g., an antenna or other circuit with communication function) connected to each other. The microwave sensing module 211 of each lighting device 21 is triggered to generate a detection signal when detecting a moving object in the target area, and broadcasts the detection signal through the communication module 212. In one embodiment, the lighting devices 21 may be light-emitting diode (LED) lighting devices. In another embodiment, the lighting devices 21 may also be fluorescent lamps, bulbs, or other similar devices.

The main control platform 22 performs anomaly detection for each lighting device 21 and stores a sensing status update table and an associated device table for each lighting device 21. In one embodiment, the main control platform 22 may be a server. In another embodiment, the main control platform 22 may also be a personal computer, laptop, smartphone, or other similar device. The sensing status update table records the identifier (ID), last trigger time, anomaly count, sensing sensitivity, sensing enable state, and remaining distance check time for each lighting device 21. For example, the sensing status update table is as shown in Table 1 given below:

| | Sensing | | | | Remaining |
|---|---|---|---|---|---|
| | enable | Sensing | Last trigger | Anomaly | distance |
| Identifier | state | sensitivity | time | count | check time |
| 88888001 | 1 | 3 | 2024 Mar. 8 | 0 | 15 |
| | | | 10:57:35 | | |
| 88888002 | 1 | 3 | 2024 Mar. 8 | 0 | 12 |
| | | | 10:57:1- | | |
| 88888003 | 0 | 1 | 2024 Mar. 1 | 3 | 9 |
| | | | 7:00:35 | | |
| 88888004 | 1 | 3 | 2024 Mar. 8 | 0 | 0 |
| | | | 10:56:55 | | |

The associated device table for each lighting device 21 records the associated lighting devices that are physically correlated with the lighting device 21 in physical space (The term “physical space” refers to the actual spatial area where these lighting devices 21 are located.). For example, the lighting device 21 and its associated lighting devices are installed on the same path, or the lighting device 21 is adjacent to its associated lighting devices. For example, the associated device table for lighting device 21 (with identifier 88888001) is as shown in Table 2 given below:

TABLE 2
Associated lighting devices
88888002
88888003
88888004
88888007

When any lighting device 21 detects a moving object in the target area, the lighting device 21 is triggered to generate a detection signal and broadcasts the detection signal to the main control platform 22 via the mesh network and gateway. Upon receiving the detection signal broadcast by any lighting device 21, the main control platform 22 updates the last trigger time of this lighting device 21 in the sensing status update table. Simultaneously, the main control platform 22 checks the remaining distance check time of this lighting device 21 in the sensing status update table. If the remaining distance check time is not 0, the main control platform 22 takes no action. If the remaining distance check time is 0, the main control platform 22 updates the remaining distance check time to the preset time interval. The unit of the preset time interval is the unit time. For example, if the preset time interval is 15 and the unit time is 1 second, then the preset time interval is 15 seconds. The above is merely an example, and both the preset time interval and unit time can be adjusted according to actual requirements. The main control platform 22 can update the sensing status update table every unit time to check the remaining distance check time of all lighting devices 21. If the remaining distance check time of a lighting device 21 is 0, the main control platform 22 takes no action. If the remaining distance check time of a lighting device 21 is not 0, the main control platform 22 decreases the remaining distance check time by 1. If the remaining distance check time of a lighting device 21 is 1, the main control platform 22 decreases it by 1 and performs anomaly detection for this lighting device 21.

When performing anomaly detection for any lighting device 21, the main control platform 22 compares the last trigger time of the lighting device 21 and the associated device table with the sensing status update table. The main control platform 22 determines that the lighting device 21 is normal when the main control platform 22 judges that the last trigger times of some of the associated lighting devices are within the preset time interval and the quantity of these devices is greater than or equal to a preset number. In this embodiment, the last trigger time of this lighting device 21 is the center time point of the preset time interval. In another embodiment, the last trigger time of this lighting device 21 is the end time point of the preset time interval. Then, the main control platform 22 adjusts the anomaly count of the lighting device 21 in the sensing status update table to 0. For example, if the preset time interval is 15 seconds and the preset number is 2, the main control platform 22 checks whether more than 2 associated lighting devices have their last trigger times within ±7.5 seconds of this lighting device 21's last trigger time. If so, the main control platform 22 determines this lighting device 21 is normal and adjusts its anomaly count to 0 in the sensing status update table.

The main control platform 22 determines that the lighting device 21 is abnormal when the main control platform 22 judges that the last trigger times of some of the associated lighting devices are within the preset time interval but the quantity of these devices is below the preset number. Then, the main control platform 22 increases the anomaly count of the lighting device 21 in the sensing status update table by 1. For example, if the main control platform 22 finds only one associated lighting device with its last trigger time within ±7.5 seconds of this lighting device 21's last trigger time, it determines this lighting device 21 is abnormal and increases its anomaly count by 1 in the sensing status update table.

When increasing the anomaly count of a lighting device 21 in the sensing status update table by 1 and the anomaly count reaches the anomaly upper limit, the main control platform 22 resets the anomaly count to 0. Then, if the sensing sensitivity of this lighting device 21 is not 1, the main control platform 22 decreases it by 1. The main control platform 22 sends an adjustment signal to this lighting device 21 to reduce its sensing sensitivity. For example, if the anomaly upper limit is 5 and the current sensing sensitivity of this lighting device 21 is 2, when increasing its anomaly count to 5, the main control platform 22 resets the anomaly count to 0. Then, the main control platform 22 decreases the lighting device 21's sensing sensitivity from 2 to 1.

When the sensing sensitivity of a lighting device 21 is 1, the main control platform 22 adjusts its sensing enable status to 0 to disable its microwave sensing function. For example, if the anomaly upper limit is 5 and the current sensing sensitivity of this lighting device 21 is 1, when increasing its anomaly count to 5, the main control platform 22 resets the anomaly count to 0. Then, the main control platform 22 sets the sensing enable status of this lighting device 21 to 0, disabling its microwave sensing function.

This embodiment provides a lighting control system 2 with microwave sensing anomaly detection function, which includes a plurality of lighting devices 21 and a main control platform 22. These lighting devices 21 are distributed in the target area. Each lighting device 21 generates and broadcasts a detection signal when detecting a moving object in the target area. The main control platform 22 performs anomaly detection for each lighting device 21 and maintains a sensing status update table recording the last trigger time and anomaly count of each lighting device 21, as well as an associated device table for each lighting device 21. The associated device table records a plurality of associated lighting devices 21 that are physically connected in the physical space. When performing anomaly detection for any lighting device 21, the main control platform 22 compares the lighting device 21's last trigger time and associated device table with the sensing status update table. The main control platform 22 determines the lighting device 21 is normal when the main control platform 22 judges that the last trigger times of some associated lighting devices are within the preset time interval and their quantity meets or exceeds the preset number, then resets its anomaly count to 0.

In this embodiment, the last trigger time of the lighting device 21 can be either the center time point or end time point of the preset time interval.

In this embodiment, the main control platform 22 determines the lighting device 21 is abnormal when the main control platform 22 judges that the last trigger times of some associated lighting devices are within the preset time interval but their quantity is below the preset number, then increases its anomaly count by 1.

In this embodiment, the sensing status update table also records the sensing sensitivity of each lighting device 21. When increasing a lighting device 21's anomaly count to reach the anomaly upper limit, the main control platform 22 resets the anomaly count to 0. Then, if the lighting device 21's sensing sensitivity is not 1, the main control platform 22 decreases the sensitivity by 1.

In this embodiment, the sensing status update table also records the sensing enable status of each lighting device 21. When a lighting device 21's sensing sensitivity is 1, the main control platform 22 sets its sensing enable status to 0 to disable the microwave sensing function.

It is worthy to point out that the microwave sensing module of a lighting device is prone to self-excitation due to ripple or environmental interference, thereby generating erroneous detection signals and causing its object detection function to malfunction. As a result, the lighting device may remain activated even when no moving object is detected. However, currently available lighting control systems lack effective anomaly detection function and thus cannot adequately address the aforementioned issue. By contrast, according to the embodiments of the present invention, through the aforementioned lighting device management mechanism based on the sensing status update table and associated device table, the lighting control system can effectively reduce the sensitivity of any lighting device whose microwave sensing function becomes abnormal due to self-excitation, thereby avoiding erroneous detection signals. Consequently, the lighting control system ensures that the lighting system including these lighting devices operates normally to meet actual requirements.

Furthermore, according to the embodiments of the present invention, when performing anomaly detection for a lighting device, the main control platform of the lighting control system compares the lighting device's last trigger time and associated device table with the sensing status update table. The main control platform determines whether the lighting device is normal or abnormal based on whether the number of associated lighting devices whose last trigger times fall within the preset time interval meets or falls below a preset threshold. Here, the center time point or end time point of the preset time interval is the last trigger time of the lighting device. Thus, this preset time interval forms a time window based on the lighting device's last trigger time. This unique time-window mechanism provides the lighting control system with a basis for determining whether a lighting device is normal or abnormal, enabling the system's microwave sensing anomaly detection function to achieve high accuracy.

Moreover, according to the embodiments of the present invention, the sensing status update table stored by the main control platform of the lighting control system also records the remaining distance check time for each lighting device. The main control platform refreshes the sensing status update table every unit time and periodically performs anomaly detection for each lighting device based on their respective remaining distance check times. Through this mechanism, the lighting control system can efficiently manage all lighting devices, ensuring the proper operation of the lighting system.

Additionally, according to the embodiments of the present invention, the microwave sensing anomaly detection functionality of the lighting control system ensures the normal operation of the lighting system, allowing the lighting control system to be effectively applied to various intelligent systems, such as intelligent home systems, intelligent parking systems, or other similar systems. Therefore, the lighting control system has broader applicability and aligns with future development trends.

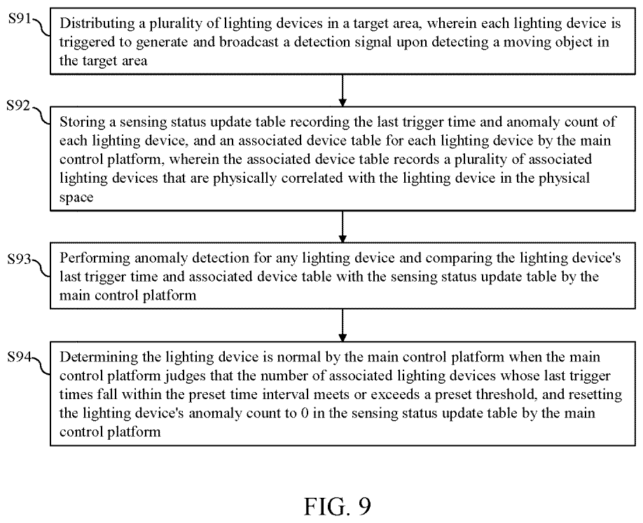

Please refer to FIG. 9, which is a first flow chart of a microwave sensing anomaly detection method for lighting control system in accordance with a sixth embodiment of the present invention. As shown in FIG. 9, the method includes the following steps:
Step S91: distributing a plurality of lighting devices in a target area, wherein each lighting device is triggered to generate and broadcast a detection signal upon detecting a moving object in the target area.
Step S92: storing a sensing status update table recording the last trigger time and anomaly count of each lighting device, and an associated device table for each lighting device by the main control platform, wherein the associated device table records a plurality of associated lighting devices that are physically correlated with the lighting device in the physical space.
Step S93: performing anomaly detection for any lighting device and comparing the lighting device's last trigger time and associated device table with the sensing status update table by the main control platform.
Step S94: determining the lighting device is normal by the main control platform when the main control platform judges that the number of associated lighting devices whose last trigger times fall within the preset time interval meets or exceeds a preset threshold, and resetting the lighting device's anomaly count to 0 in the sensing status update table by the main control platform. The lighting device's last trigger time serves as either the center time point or end time point of the preset time interval.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

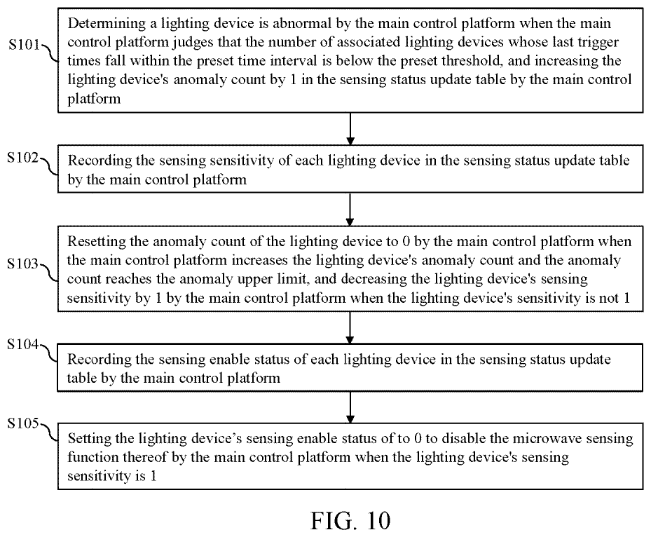

FIG. 10 is a second flow chart of the microwave sensing anomaly detection method for lighting control system in accordance with the sixth embodiment of the present invention. As shown in FIG. 10, the method further includes the following steps:
Step S101: determining a lighting device is abnormal by the main control platform when the main control platform judges that the number of associated lighting devices whose last trigger times fall within the preset time interval is below the preset threshold, and increasing the lighting device's anomaly count by 1 in the sensing status update table by the main control platform.
Step S102: recording the sensing sensitivity of each lighting device in the sensing status update table by the main control platform.
Step S103: resetting the anomaly count of the lighting device to 0 by the main control platform when the main control platform increases the lighting device's anomaly count and the anomaly count reaches the anomaly upper limit, and decreasing the lighting device's sensing sensitivity by 1 by the main control platform when the lighting device's sensitivity is not 1.
Step S104: recording the sensing enable status of each lighting device in the sensing status update table by the main control platform.
Step S105: setting the lighting device's sensing enable status of to 0 to disable the microwave sensing function thereof by the main control platform when the lighting device's sensing sensitivity is 1.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the present invention, the lighting device includes a communication module, a memory module, a microwave sensing module, a control module, and a light-emitting module. The memory module is connected to the communication module and stores an aging table and a suspect count. The aging table records a plurality of trigger records, and the trigger records are the time points at which the communication module receives the activation signals transmitted from other lighting devices within a preset time interval. The microwave sensing module detects a moving object and generates a detection signal. The control module is connected to the communication module, the microwave sensing module, and the memory module. The light-emitting module is connected to the control module. The control module checks the aging table when the microwave sensing module generates the detection signal, and sets the suspect count to an initial value when determining that a preset number of the trigger records exist within a time window. The control module generates the activation signal based on the detection signal to activate the light-emitting module, and broadcasts the activation signal via the communication module. Via the above-self-testing function, the lighting device can self-detect self-excitation, and actively reduces the sensitivity of or deactivates the microwave sensing module when self-excitation repeatedly occurs in order to prevent the faulty lighting device from affecting the group sensing function of other lighting devices. Thus, the lighting system can automatically ignore the microwave sensing function of the faulty lighting device so as to ensure the normal operation of the lighting system. Thus, the lighting system can meet actual requirements.

Also, according to one embodiment of the present invention, when the microwave sensing module of the lighting device generates the detection signal, the control module checks the aging table and adjusts the suspect count based on whether the preset number of trigger records exist within the time window. The central point of the time window is the time point when the detection signal is generated. This time window mechanism enables the lighting device to accurately determine whether other lighting devices also detected the moving object and generated detection signals within a fixed period before and after the time point when the detection signal was generated, serving as a reference for the control module to determine whether the microwave sensing module has self-excitation. Therefore, this time window mechanism can effectively enhance the aforementioned self-testing function, so the self-testing function can be more precise.

Further, according to one embodiment of the present invention, the control module of the lighting device can execute the self-testing function based on a specially designed aging table, where the endpoint of the preset time interval of the aging table is the time point of the most recently generated trigger record. Thus, the aging table is based on the time dimension. That is to say, the control module can continuously update the aging table, which improves the accuracy of the aforementioned self-testing function to prevent the lighting device from generating erroneous detection signals. In this way, the aforementioned self-testing mechanism can ensure normal operation of the lighting system.

Moreover, according to one embodiment of the present invention, the self-testing function of the lighting device ensures normal operation of the lighting system, enabling effective application of the lighting device in various intelligent systems such as intelligent home systems, intelligent parking systems or other intelligent systems. Therefore, the lighting device can be more comprehensive in application and aligns with the future development trend.

Furthermore, according to one embodiment of the present invention, the lighting device features simple design and can implement the self-testing function through a simple and efficient mechanism. Thus, the lighting device can achieve desired effects without significantly increasing costs, so the practicality of the lighting device can be enhanced. Therefore, the lighting device can meet requirements of different applications.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lighting device with self-testing and group control functions, comprising:
a communication module;
a memory module, connected to the communication module and configured to store an aging table and a suspect count, wherein the aging table is configured to record a plurality of trigger records, and the trigger records are time points at which the communication module receives activation signals transmitted from other lighting devices within a preset time interval;
a microwave sensing module, configured to detect a moving object and generate a detection signal;
a control module, connected to the communication module, the microwave sensing module, and the memory module; and
a light-emitting module, connected to the control module;
wherein the control module is configured to check the aging table when the microwave sensing module generates the detection signal, and set the suspect count to an initial value when determining that a preset number of the trigger records exist within a time window, wherein the control module is configured to generate the activation signal based on the detection signal to activate the light-emitting module, and broadcast the activation signal via the communication module.

2. The lighting device with self-testing and group control functions as claimed in claim 1, wherein a central point of the time window is a time point when the detection signal is generated.

3. The lighting device with self-testing and group control functions as claimed in claim 1, wherein the control module is configured to check the aging table when the microwave sensing module generates the detection signal, increase the suspect count by 1 and reduce a sensitivity of the microwave sensing module when determining that the preset number of the trigger records do not exist within the time window, wherein the control module is configured to generate the activation signal based on the detection signal to activate the light-emitting module, and broadcast the activation signal via the communication module.

4. The lighting device with self-testing and group control functions as claimed in claim 1, wherein the control module is configured to check the aging table when the microwave sensing module generates the detection signal, increase the suspect count by 1 and set the microwave sensing module to an abnormal state when determining that the preset number of the trigger records do not exist within the time window and the suspect count exceeds a preset upper limit, wherein the control module is configured to deactivate the microwave sensing module after the microwave sensing module is in the abnormal state.

5. The lighting device with self-testing and group control functions as claimed in claim 1, wherein an endpoint of the preset time interval of the aging table is a time point of a most recent trigger record generated.

6. A self-testing method for lighting device with group control function, comprising:
storing an aging table and a suspect count by a memory module, wherein the aging table is configured to record a plurality of trigger records, and the trigger records are time points at which a communication module receives activation signals transmitted from other lighting devices within a preset time interval;
detecting a moving object by a microwave sensing module to generate a detection signal;
checking the aging table when the microwave sensing module generates the detection signal, and setting the suspect count to an initial value when determining that a preset number of the trigger records exist within a time window by a control module;
generating the activation signal based on the detection signal to activate a light-emitting module by the control module; and
broadcasting the activation signal via the communication module by the control module.

7. The self-testing method for lighting device with group control function as claimed in claim 6, wherein a central point of the time window is a time point when the detection signal is generated.

8. The self-testing method for lighting device with group control function as claimed in claim 6, further comprising:
increasing the suspect count by 1 and reducing a sensitivity of the microwave sensing module when determining that the preset number of the trigger records do not exist within the time window by the control module;
generating the activation signal based on the detection signal to activate the light-emitting module by the control module; and
broadcasting the activation signal via the communication module by the control module.

9. The self-testing method for lighting device with group control function as claimed in claim 8, further comprising:
increasing the suspect count by 1 and setting the microwave sensing module to an abnormal state when determining that the preset number of the trigger records do not exist within the time window and the suspect count exceeds a preset upper limit by the control module; and
deactivating the microwave sensing module by the control module after the microwave sensing module is in the abnormal state.

10. The self-testing method for lighting device with group control function as claimed in claim 6, wherein an endpoint of the preset time interval of the aging table is a time point of a most recent trigger record generated.
